(19) United States
(12) Patent Application Publication
(10) Pub. No.: US 2009/0044223 A1
(43) Pub. Date: Feb. 12, 2009

(54) BROADCAST/VOD RECEIVER AND VIEWING MANAGEMENT METHOD

(75) Inventors: Tang Jiang, Fukaya-shi (JP); Katsumi Kaga, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/187,756

(22) Filed: Aug. 7, 2008

(30) Foreign Application Priority Data
Aug. 8, 2007 (JP) 2007-206954

(51) Int. Cl. H04N 5/445; G06F 13/00; H04N 7/173

(52) U.S. Cl. 725/40; 725/44; 725/58; 725/100

(57) ABSTRACT

According to one embodiment, a broadcast/VOD receiver comprises a broadcast reception processing unit which selectively receives broadcast signals and reproduces content of broadcast programs, a VOD communication processing unit which communicates with a server providing VOD content to acquire the VOD content, an EPG information acquisition unit which acquires EPG information, a viewing reservation unit which makes reservations for viewing the VOD content to the server, a display data generation unit which creates a schedule table of the broadcast programs on the basis of the EPG information, adds list information columns displaying list information of the VOD content on the schedule table, and inserts viewing schedules corresponding to viewing reservations for the VOD content to the list information columns to generate display data, and a display processing unit which reproduces to output the display data and display the schedule table on a display screen of a display unit.

### CROSS-REFERENCE TO RELATED APPLICATIONS

This application is based upon and claims the benefit of priority from Japanese Patent Application No. 2007-206954, filed Aug. 8, 2007, the entire contents of which are incorporated herein by reference.

### BACKGROUND

1. Field

One embodiment of the invention relates to a broadcast/video on demand (VOD) receiver which has both functions of receiving a broadcast program in an on-air state and of receiving content to be distributed from a VOD content server. More specifically, one embodiment of the invention relates to a viewing management method for appropriately displaying an electronic program guide (EPG) in order to introduce a broadcast schedule of broadcast programs and a play list in order to introduce VOD content to the user and for managing a viewing schedule.

2. Description of the Related Art

A conventional broadcast receiver acquires EPG data in which broadcast schedules of broadcast programs to be on-air are put together from broadcast signals and displays a schedule table of the broadcast programs based on EPG on a screen of a display unit in response to a request from a user. If the user becomes a member of a distribution service of the VOD content and the conventional broadcast receiver can receive a distribution of the VOD content from the VOD content server via a network, the receiver acquires a content play list from the server to display the play list on the screen of the display unit in response to the request from the user.

Meanwhile, when the user makes a viewing reservation for a broadcast program to be on-air by referring to the EPG, the user wants to view the VOD content by utilizing spare time sometimes. At that time, it is very inconvenient for the user because the user has to selectively switch between an EPG display for the broadcast programs and a display of a viewing schedule list of the VOD content to be reserved for viewing and compare both of them. When the user makes a viewing reservation of the VOD content (a serial) in which video content continues, the user has to individually specify the viewing schedule of the whole content and it poses a very complicated procedure of the user.

For instance, a proposal of a schedule method capable of making continuous recording reservations for the broadcast programs to be on-air is disclosed in a proposal for a conventional viewing management method (refer to Jpn. Pat. Appln. KOKAI Publication No. 3774683); however, a proposal in relation to cooperation with the display of the content play list of the VOD is not disclosed therein.

As mentioned above, since the conventional broadcast/VOD receiver separately functions as the display for the broadcast schedule of the broadcast programs and as the display for the viewing schedule list of the VOD content, the user has to switch to compare between each display for selecting the viewing of the broadcast programs and the VOD content. This situation has given the user much trouble. The user has to perform input setting to make reservations for the VOD content for each content item, and especially, the user has to follow complicated procedures for the serial, etc.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating a system configuration using a television receiver as one embodiment of a broadcast/VOD receiver regarding the present invention;

FIG. 2 is a block diagram illustrating a concrete configuration of a program-list display function equipped with the receiver shown in FIG. 1;

FIG. 3 is a view illustrating a display example of a content list retrieved by a key word ‘Baseball’ from a content server in the receiver shown in FIG. 2;

FIG. 4 is a view illustrating a display example of a content specified purchase screen to be presented if there is a charge for content after inputting a specification of ‘DECIDE’ for the content list shown in FIG. 3;

FIG. 5 is a view illustrating a display example of a screen to select viewing or reservation after specifying content purchase on the screen shown in FIG. 4;

FIG. 6 is a view illustrating a display example of a reservation screen of a specified viewing time zone to be presented after inputting a specification of ‘RESERVE’ on the screen shown in FIG. 5;

FIG. 7 is a view illustrating a display example of a screen to make a reservation of loop viewing through automatic date specification if the length of the content specified on the screen shown in FIG. 6 is longer than the reserved time zone;

FIG. 8 is a view illustration a display example of a content list retrieved by the key word ‘Baseball’ from the content server in the receiver similarly shown in FIG. 3;

FIG. 9 is a view illustrating a display example of a favorite box screen to be presented after inputting a specification of ‘BLUE’ on the screen shown in FIG. 8;

FIG. 10 is a view illustrating a display example of a specification reservation screen in a viewing time zone to be presented after inputting a specification of ‘DECIDE’ on the screen shown in FIG. 9;

FIG. 11 is a view illustrating a display example of a screen to make a reservation for loop viewing by specifying data if the total length of a favorite box shown in FIG. 9 is longer than that of a reserved time zone;

FIG. 12 is a view illustrating a display example of a screen to be presented if the favorite box of the viewing reservation made by specification input on the screen shown in FIG. 11 is overlapped with a time of other reserved program;

FIG. 13 is a view illustrating a display example displaying a content play list in a retrieved content reservable time zone to be presented if a specification of ‘YES’ is input on a screen shown in FIG. 12;

FIG. 14 is a view illustrating a display example of a display screen of a reservation list retrieved in FIG. 13;

FIG. 15 is a view illustrating a display list of a broadcast program table to be displayed if the whole content shown in FIG. 14 is reserved for viewing;

FIG. 16 is a flowchart illustrating a flow of procedures of the foregoing embodiment;

FIG. 17 is a view illustrating an example of a reservation list of the foregoing embodiment; and

FIG. 18 is a view illustrating a flow of processing until completion of view reservation after acquiring VOD list information of the foregoing embodiment.

### DETAILED DESCRIPTION

Various embodiments according to the invention will be described hereinafter with reference to the accompanying drawings. In general, according to one embodiment of the invention, there is provided a broadcast/VOD receiver, comprising a broadcast reception processing unit which selectively receives broadcast signals and reproduces content of broadcast programs, a VOD communication processing unit which communicates with a server providing VOD content via a communication line to acquire the VOD content, an electronic program guide information acquisition unit which acquires electronic program guide information showing broadcast dates, times, and content of the broadcast programs, a viewing reservation unit which makes reservations for viewing the VOD content to the server through the VOD communication processing unit, a display data generation unit which creates a schedule table of the broadcast programs on the basis of the electronic program guide information, adds list information columns displaying list information of the VOD content on the schedule table, and inserts viewing schedules corresponding to viewing reservations for the VOD content into the list information columns to generate display data, and a display processing unit which reproduces to output the display data generated from the display data generation unit and displays the schedule table on a display screen of a display unit.

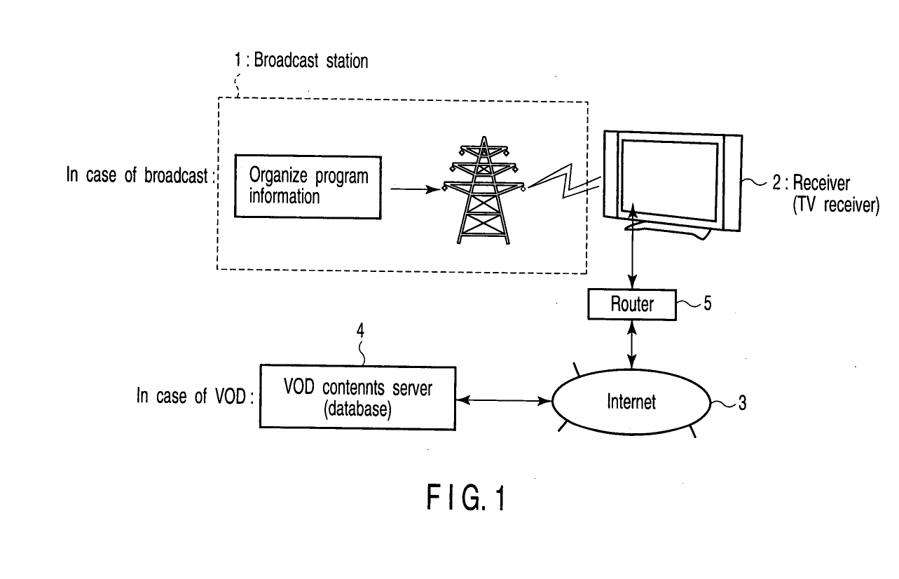

FIG. 1 shows a block diagram depicting a system configuration using a television (TV) receiver as one embodiment of a broadcast/VOD receiver regarding the invention. In FIG. 1, the reference number 1 designates a broadcast station; the broadcast station 1 acquires program information in broadcasting (at on-air) a program, and edits the program information to transmit the edited program information together with program content. A TV receiver 2 receives this program information to edit in a form for a broadcast program table and displays the list on a screen. Meanwhile, in a VOD, a content server 4 connected to the Internet 3 provides list information of video content registered in a database. The receiver 2 accesses the content server 4 via a router 5 and the Internet 3, acquires the list information from the database to display the list information on the screen, and specifies arbitrary content to make a viewing reservation. A reservation result is displayed as a reservation list together with a list display.

In conventional, since the broadcast program table and the viewing schedule list table of the VOD content are separately selected and displayed, when deciding both the viewing schedules, a user has to compare between both the tables by switching them. Therefore, the receiver 2 of the embodiment integrally manages the respective display content, partially combines viewing schedule list display columns of the VOD content as a frame of the broadcast program table, and then, makes a load lighten on a selective operation to decide the viewing schedule of the user.

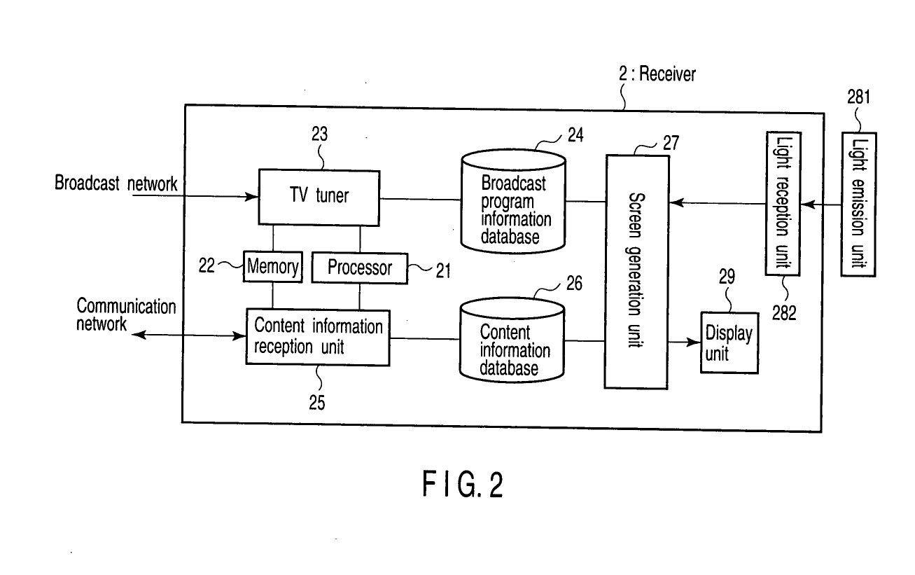

FIG. 2 shows a block diagram depicting a concrete configuration of a display function of a broadcast program table-VOD content viewing schedule list table (hereinafter referred to as a program-list table) of the receiver 2 shown in FIG. 1. In FIG. 2, a processor 21 stores broadcast program information to be extracted from a digital broadcast signal via a broadcast network through a TV tuner 23, generates a broadcast program information database 24, acquires content list information from a VOD content server via a communication network by means of a content information reception unit 25, and generates a content information database 26.

A screen generation unit 27 creates a broadcast program table from the broadcast program information stored in the database 24, and incorporates the content list information stored in the content information database 26 in the frame of the program table. When either the broadcast program or the VOD content is selected by a retrieval method, such as a taste, a category, a day of the week input by the user through a remote controller (a light emission unit 281 and a light reception unit 282 in FIG. 2), the generation unit 27 edits the broadcast program table on the basis of the selected information to display the program table on a display unit (display) 29.

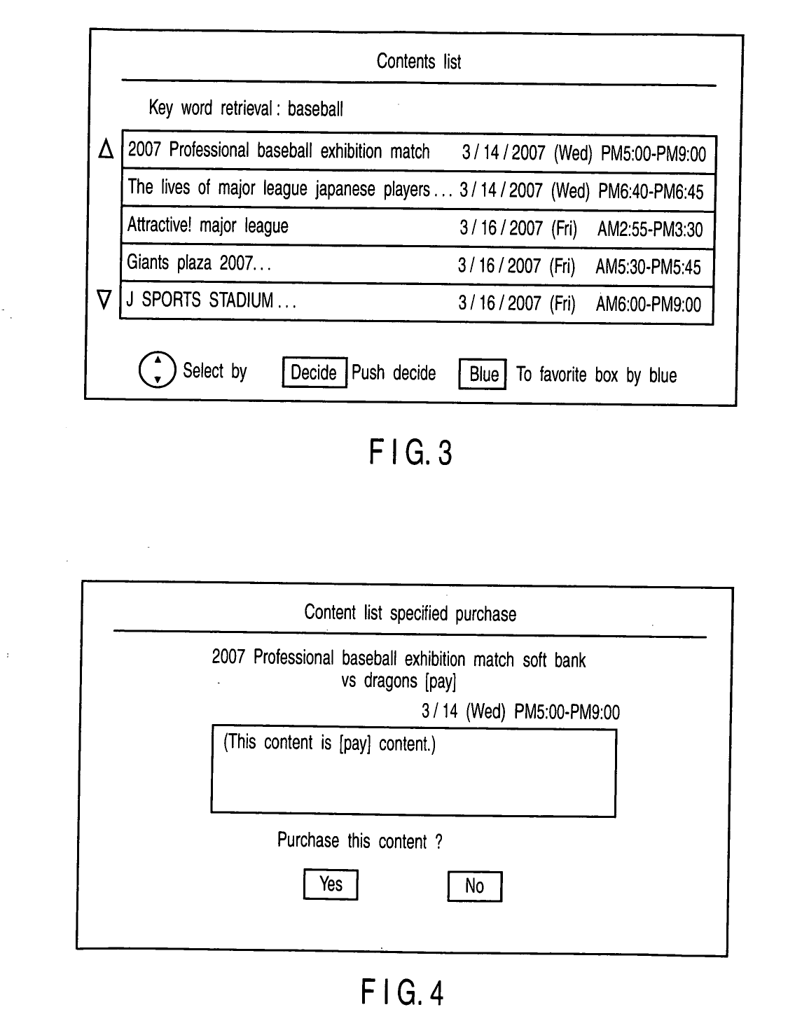

An embodiment of the receiver 2, being configured as mentioned above, will be described with reference to FIGS. 3-18.

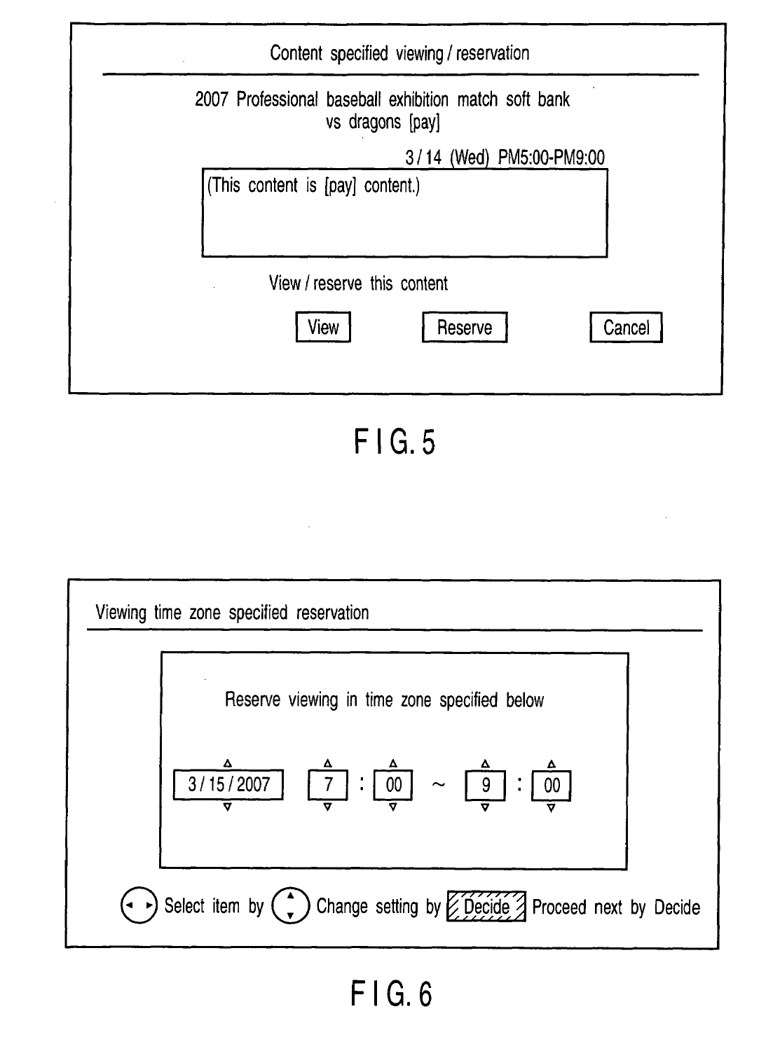

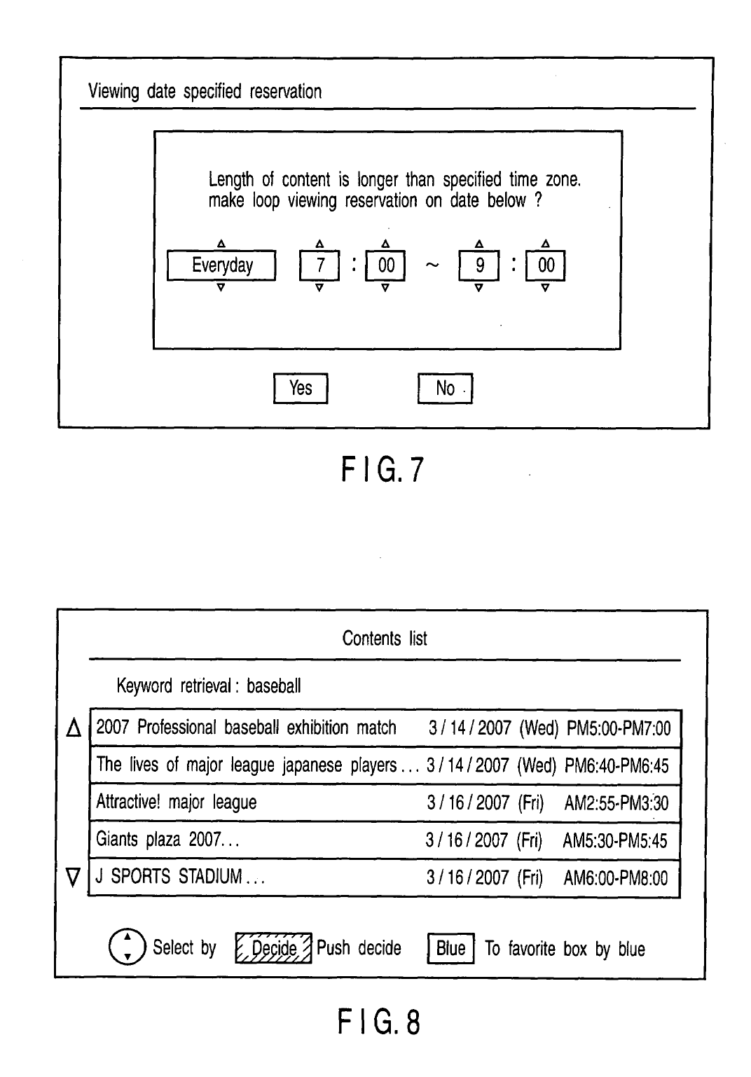

At first, each reference view will be described. FIG. 3 shows a display example of a content list retrieved by a key word ‘Baseball’ from the content server 4. FIG. 4 shows a display example of a content specified purchase screen to be presented when there is the charge for the content after inputting the specification of ‘DECIDE’ shown in FIG. 3. FIG. 5 shows a display example of the screen to select the viewing or reservation after instructing content purchase on the screen shown in FIG. 4. FIG. 6 shows a display example of the reservation screen for specifying the viewing time zone to be presented after inputting the specification of ‘RESERVE’ on the screen shown in FIG. 5. FIG. 7 shows a display example of the screen to make the reservation for the loop viewing by automatically specifying the date if the length of the specified content is longer than that of the reserved time zone.

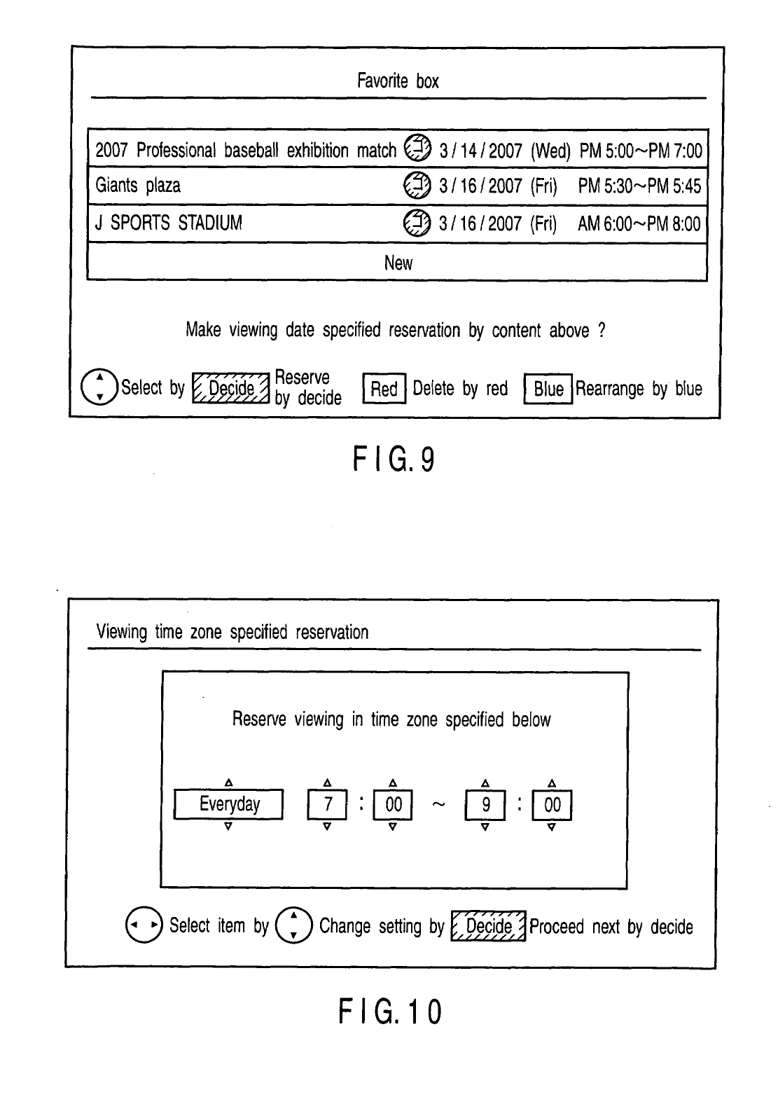

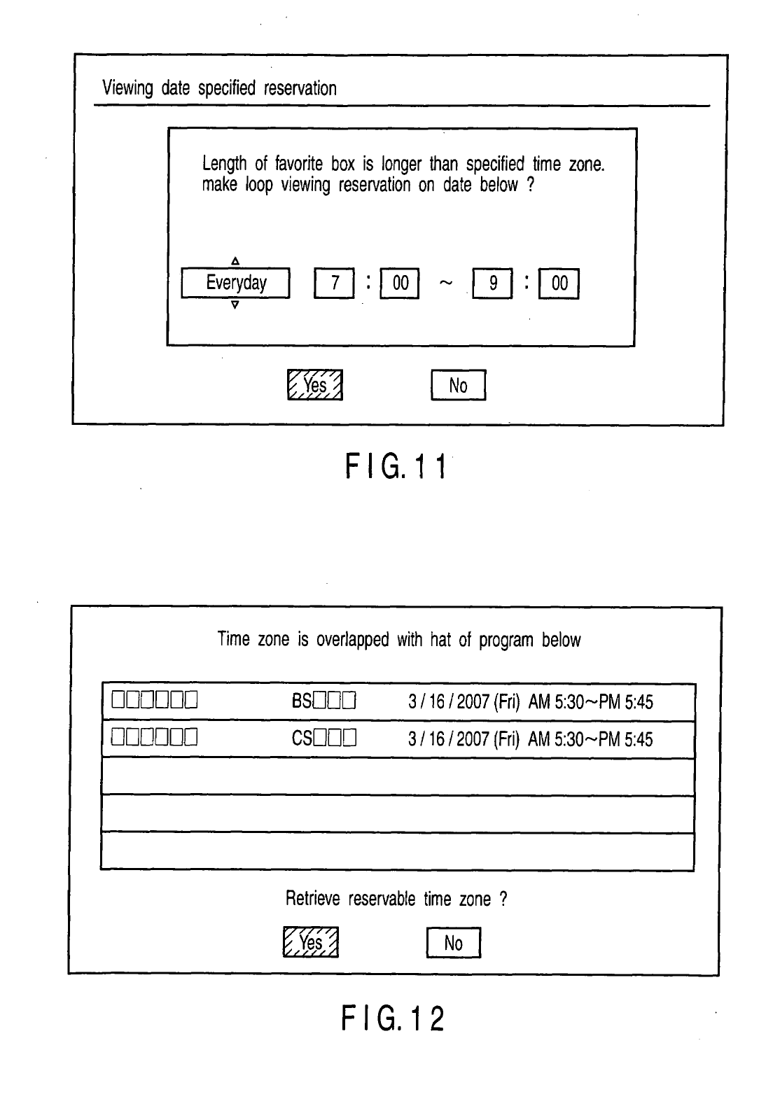

FIG. 8 shows a display example of the content list retrieved by the key word ‘Baseball’ from the content server 4 in the same way as that of FIG. 3. FIG. 9 shows a display example of a favorite box screen to be presented after inputting the specification ‘BLUE’ on the screen shown in FIG. 8, and the content selected from the content list is registered to be displayed on the box screen in a list form. FIG. 10 shows a display example of the reservation screen for specifying the viewing time zone to be presented after inputting the specification of ‘DECIDE’ on the screen shown in FIG. 9, here, a date, a time and a minute may be specified. FIG. 11 shows a display example of the screen to make the reservation for the loop viewing by specifying the date if the total length of the favorite box is longer than the reserved time zone.

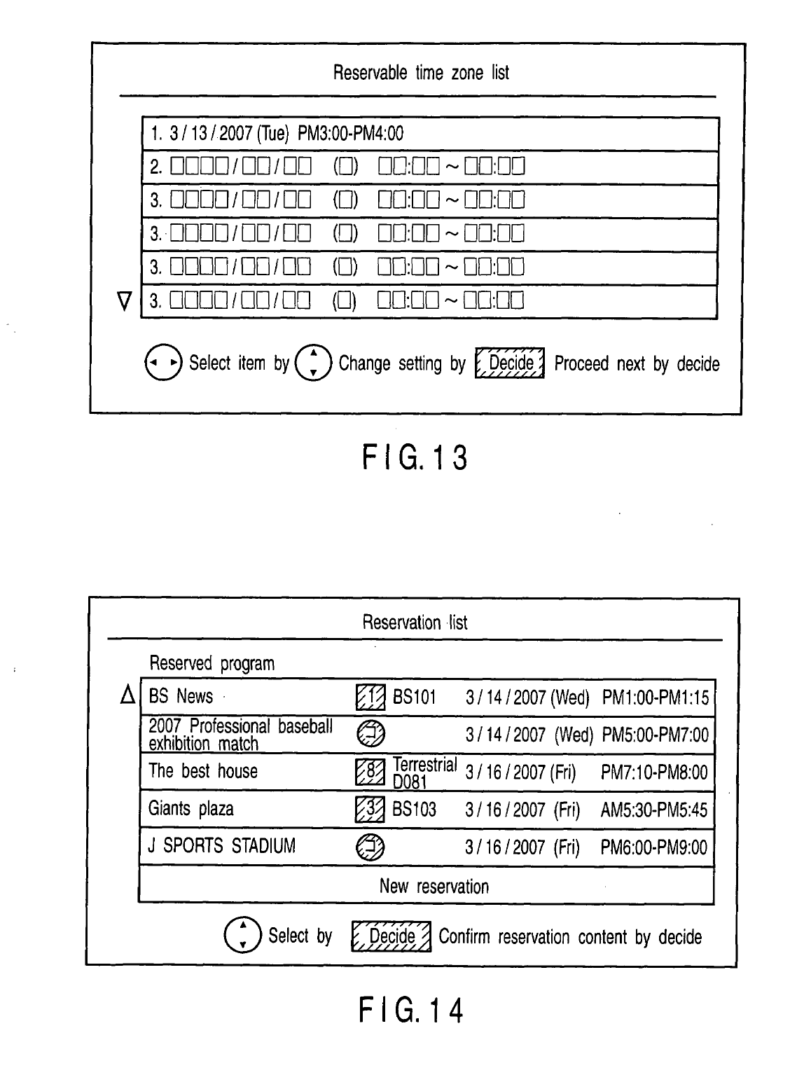

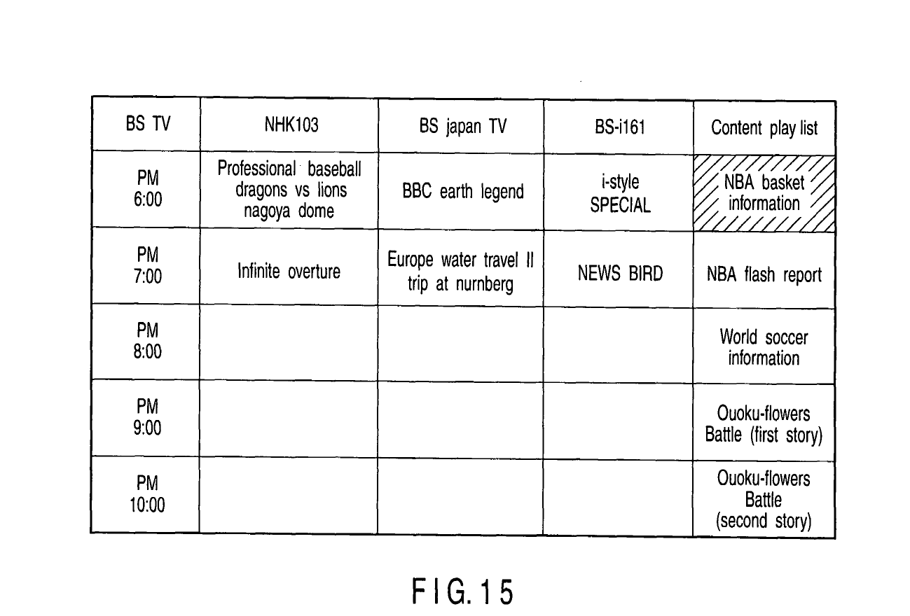

FIG. 12 shows a screen to be presented if the favorite box of the viewing reservation which has been input and specified on the screen shown in FIG. 11 is overlapped with the times of the other reserved programs. The overlapped reservation programs are displayed on the screen in a list form. Under taking care the overlapped time zones and expecting to find other spare times, the user has to input to specify ‘YES’. FIG. 13 shows a display example showing the content play list in the retrieved reservation time zone and being presented if ‘YES’ is input as the specification on the screen shown in FIG. 12. FIG. 14 is a reservation list screen, and the specified content is registered in the reservation list after inputting the specification ‘DECIDE’. FIG. 15 shows a display example of the broadcast program table to be displayed if the reservation for the whole content is made from 6:00 PM to 11:00 PM.

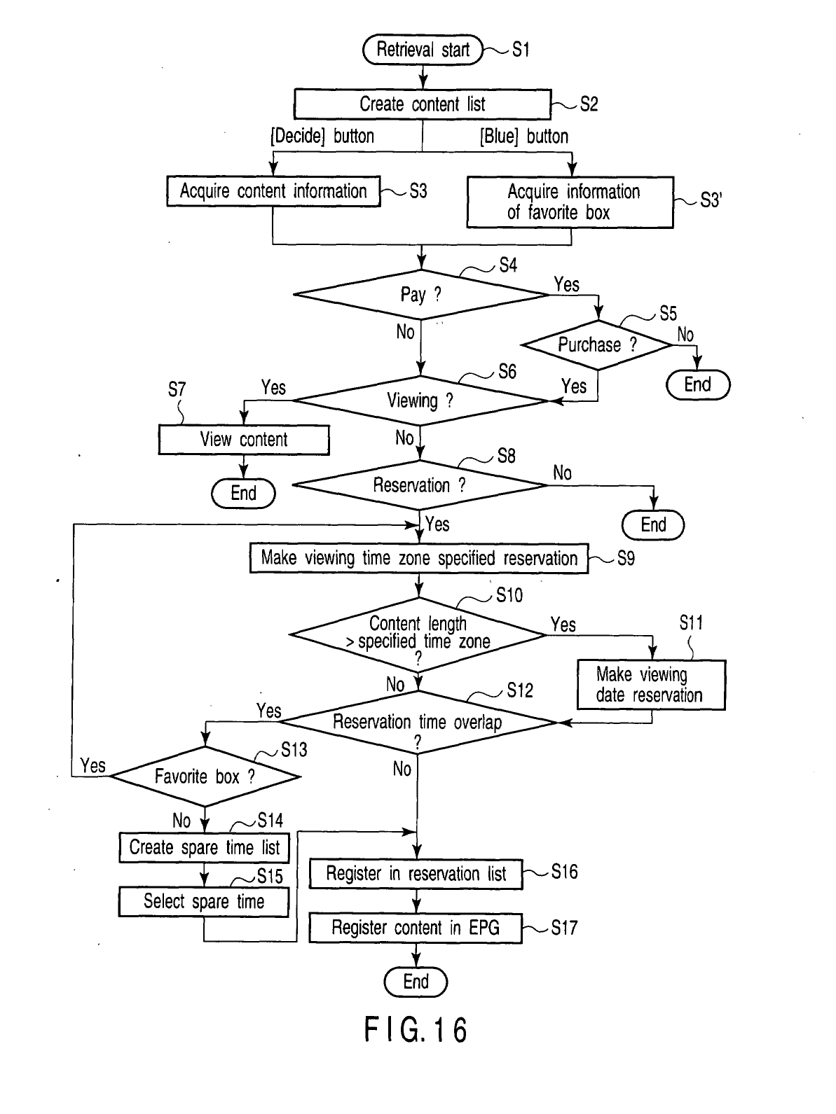

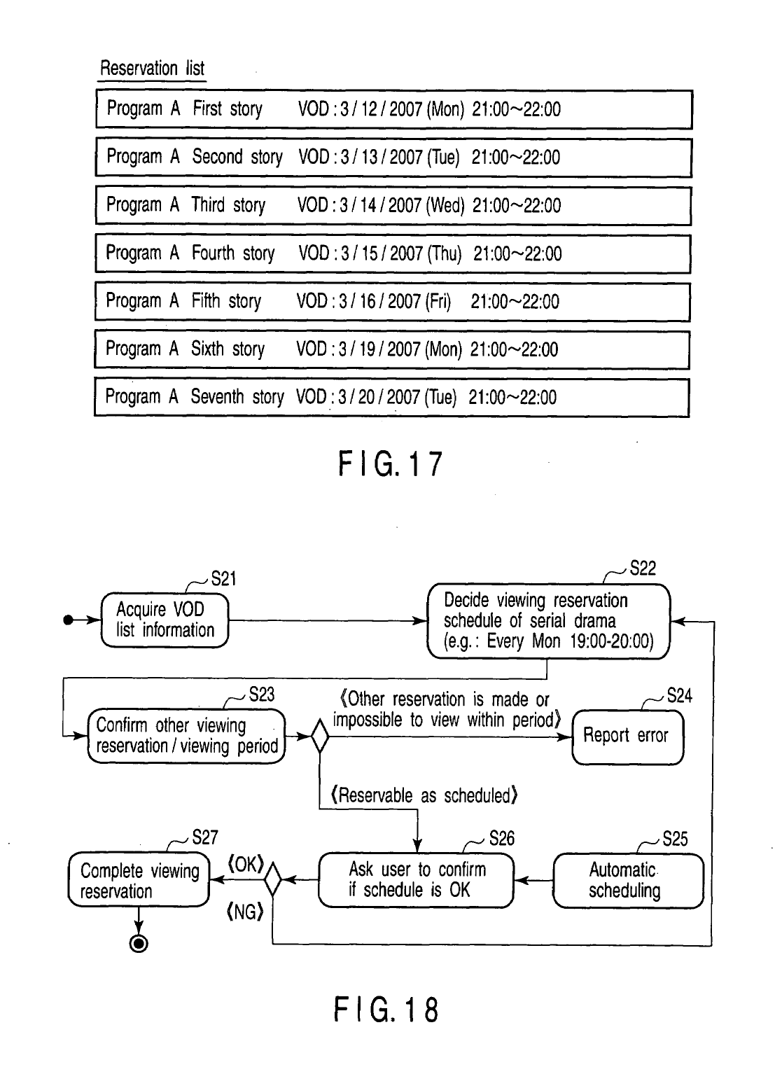

FIG. 16 shows a flowchart illustrating the flow of the procedures of the embodiment, FIG. 17 shows a reservation list example of the embodiment, and FIG. 18 shows a view depicting the flow of the processing to the reservation of the embodiment.

The processing operations of the embodiment will be described with reference to the flowchart shown in FIG. 16.

In Step S1, the content server 4 starts to retrieve content on the basis of condition information specified by the user. In Step S2, the content server 4 creates the content list from a result of the retrieval. For instance, retrieving the content list under the condition of the key word ‘Baseball’ creates the content list shown in FIG. 3. In Step S3, the user selects a content to acquire content information. Here, if ‘DECIDE’ is specified and input, the server 4 acquires the information on the specified content. In Step S3′, if ‘BLUE’ that is a processing symbol by function is specified and input, the server 4 registers the specified content in the favorite box to acquire the content.

In Step S4, the server 4 determines whether or not there is a charge for the specified content, and if there is no charge therefor, the processor 4 proceeds to Step S6, if there is a charge therefor, the server 4 presents the purchase screen as shown in FIG. 4. In Step S5, if ‘PURCHASE’ is specified and input, the procedure proceeds to Step S6. If ‘DON'T PURCHASE’ is specified and input, the processing ends. In Step S6, the server 4 presents the content specification viewing/reservation screen shown in FIG. 5 and receives the determination from the user whether the specified content should be viewed, or the reservation should be made or cancelled. If ‘CANCEL’ is specified, the procedure returns to Step S4, the server 4 receives again from the user whether purchase should be done or not.

In Step S9, it is determined whether or not the length of the content which has been reserved for viewing in Step S9 is longer than that of the time zone (Step S10), and if the length of the content is longer, the server 4 makes the viewing date specification reservation shown in FIG. 7 automatically or by the user's specification to make the loop viewing reservation (Step S11). If the length of the content is not longer than that of the reservation time zone, the procedure proceeds to Step S12.

In Step S12, it is determined whether the reserved time is overlapped with other programs which have been reserved already, if overlapped, the server 1, for example, reads again the content specified by the user from the content list shown in FIG. 8 to determine whether or not the content has been registered already in the favorite box shown in FIG. 9 (Step S13). If registered already, the procedure returns to Step S7 to execute a series of processing. If not registered already, the server 4 creates the list of spare times (Step S14), makes the user select any spare time (Step S15), and registers the selected time in the reservation time (Step S16).

Meanwhile, if the viewing time zone shown in FIG. 10 is specified and input, further, if the viewing date specification reservation shown in FIG. 11 is made, the server 4 determines the overlap of the reserved times (Step S12). If the times are overlapped, the server 4 presents the reservation overlap as shown in FIG. 12 to make the user select the retrieval of the time zone capable of being reserved. When the retrieval of the reservable time is instructed, as the result of the retrieval, the server 4 presents the list shown in FIG. 13 to prompt the user to set again. If the times are not overlapped, the server 4 registers the list as it is in the reservation list as shown in FIG. 14 (Step S16), and registers the content in one frame of the broadcast program table by putting the time right to superpose characters (Step S17).

Meanwhile, if the programs which have been reserved by the VOD are the programs of a serial, such as a serial drama, if the server 4 sets so as to allow the programs to be automatically reserved for viewing at the time, for example, every day or a fixed time for every week, the user enables viewing the programs at the same feeling as that of a television broadcast. For instance, as shown in FIG. 17, the user may schedule the content of a serial from the VOD as if the content were provided from the broadcast programs. In the case of FIG. 15, a program A is made for viewing reservation in order from the first story between 21:00 PM to 22:00 PM on week days.

Referring now to FIG. 18, a flow to a viewing reservation will be described. After acquiring the VOD list information (Step S21), for example, if a portal site in which only serial dramas are posted, or if one story which has been happened to be selected is a part of a serial, the server 4 selects such a program, and applies the program to a reservation form to be provided by the present invention to start reservation work. After deciding the viewing reservation schedule (Step S22), the server 4 confirms that any viewing reservation for other programs is not made in the scheduled times (Step S23). The server 4 confirms that the decided viewing schedule enables completing the viewing within the viewing period of the content. If the confirmation shows that the reservations based on the specified schedule are impossible, the server 4 reports an error (Step S24), automatically schedules for a spare time (Step S25), gives a question to the user to confirm whether the schedule is acceptable or not (Step S26), and if the schedule is acceptable for the user, the server 4 completes the viewing reservation (Step S27). After reservation, the screen shown in FIG. 15 is displayed, if the schedule is not acceptable, the user makes a reservation again.

While the embodiment shown in FIG. 16 has described an example in which if the reservations are overlapped, the receiver automatically sets a tentative schedule on the moment to make the user select whether the resulting schedule is acceptable or not, a configuration to present some schedule plans to the user at the time when the overlapping of the reservations is found and make the user select any schedule among the schedule plans is possible approach. A configuration to make the user directly set a candidate date and time again at the moment is also possible approach.

If the user has missed the reserved content, or if the user makes a viewing reservation for a broadcast program later for the same time as that of the reservation schedule, it is further effective, if the receiver has a function of performing automatic scheduling for the next reserved time at the time at which the content has been automatically missed. For instance, if the second story has been missed, the second story is reserved at the time at which the third story has been reserved. Therefore, the reservation schedule poses a time lag, and moreover the receiver reschedules so that the schedule goes in the viewing period of the content. Or, making the user select whether only the second story should be shifted to the spare time on the same day, and viewing the third story is viewed depending on the original schedule is another approach.

As mentioned above, according to the receiver as configured given above, mounting the viewing schedule list of the VOD content on the broadcast program table allows the user to view the reservation information together with the broadcast program information of favorite content. However, it is assumed that the content has been extracted from the content server in accordance with category retrieval, a user's taste, etc.

The user also may set the desiring content to view it in a specified time zone. If the specified time zone is not enough to view the whole of the content, the remaining program may be reproduced in the same specified time zone on the later day. Extracting the viewing of the VOD content originally required to download for each time by binding as ‘a serial’ and making out a schedule for every day and every week to distribute the VOD content according to the schedule enables the user to view the VOD content as if it were the broadcast programs.

Since the receiver has a function of automatic scheduling so as to enable completing the viewing within the content viewing period, the user does not need to perform a complicated schedule setting operation. If the user has missed the content viewing, the receiver also may present the missed content at the next viewing reservation time. Further, after reservation, if the viewing of the broadcast program is overlapped with the time at which the viewing of the broadcast program has already been reserved, it is further effective for the receiver to take preference for the broadcast program and shift the viewing reservation of the VOD content to other time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast/video on demand (VOD) receiver, comprising:
a broadcast reception processing unit which selectively receives broadcast signals and reproduces content of broadcast programs;
a VOD communication processing unit which communicates with a server providing VOD content via a communication line to acquire the VOD content;
an electronic program guide information acquisition unit which acquires electronic program guide information showing broadcast dates, times, and content of the broadcast programs;
a viewing reservation unit which makes reservations for viewing the VOD content to the server through the VOD communication processing unit;
a display data generation unit which creates a schedule table of the broadcast programs on the basis of the electronic program guide information, adds list information columns displaying list information of the VOD content on the schedule table, and inserts viewing schedules corresponding to viewing reservations for the VOD content into the list information columns to generate display data; and
a display processing unit which reproduces to output the display data generated from the display data generation unit and displays the schedule table on a display screen of a display unit.

2. The broadcast/video on demand (VOD) receiver according to claim 1, wherein the display data generation unit inserts content information of the viewing schedule into corresponding time zones in the list information columns.

3. The broadcast/video on demand (VOD) receiver according to claim 2, wherein the display data generation unit determines whether or not a whole content is viewable in an insertion time zones from the content information inserted into the list information columns, and if the content is not wholly viewable, inserts content information showing the remaining part into a predetermined time zone.

4. The broadcast/video on demand (VOD) receiver according to claim 2, wherein:
when a plurality of VOD content items to be viewed is a serial, the display data generation unit automatically inserts individual items of content information into predetermined time zones in the list information columns in order of the individual items of the content information.

5. The broadcast/video on demand (VOD) receiver according to claim 2, wherein the display data generation sets spare time zones in advance in the list information columns, retrieves VOD content having reproduction times going in the spare time zones, and inserts content information being fit for the retrieved VOD content into the spare time zones.

6. The broadcast/video on demand (VOD) receiver according to claim 1, wherein:
when the VOD content has not been viewed even after elapse of the time zone in which the content information is inserted into the list information column, the display data generation unit retrieves the next spare time zone to insert content information of the not-viewed VOD content into the retrieved spare time zone.

7. The broadcast/video on demand (VOD) receiver according to claim 1, wherein:
when the broadcast reception processing unit includes a viewing reservation means for receiving a viewing reservation for the broadcast program from a user, the display data generation unit gives the viewing reservation for the broadcast programs preference to shift content information of the viewing schedule if a time zone in a list information column into which the content information is inserted as the viewing schedule is overlapped with a time zone of the broadcast program of which the viewing has been reserved.

8. A viewing management method for use in a broadcast/video on demand (VOD) receiver which selectively receives a broadcast signal to reproduce content of the broadcast programs, communicates with a server providing VOD content via a communication line to acquire and reproduce the VOD content, comprising: acquiring electronic program guide information showing broadcast dates, times, and content of the broadcast programs;
making reservations for the VOD content in the server;
creating a schedule table of the broadcast programs on the basis of the electronic program guide information;
adding list information columns displaying list information of the VOD content to the schedule table; inserting a viewing schedule corresponding to viewing reservations for the VOD content into the list information columns and generating display data; and
reproducing to output the display data and displaying the schedule table on a display screen of a display unit.

9. The viewing management method according to claim 8, wherein the generating display data inserts content information of the viewing schedule into the corresponding time zones in the list information columns.

10. The viewing management method according to claim 9, wherein the generating display data determines whether or not a whole content is viewable in an inserted time zone from the content information inserted in the list information columns, and if the content is not wholly viewable, inserts content information showing the remaining part into a predetermined time zone.

11. The viewing management method according to claim 9, wherein:
when a plurality of VOD content items to be viewed is a serial, the generating display data automatically inserts individual items of content information into predetermined time zones in the list information columns in order of the individual items of the content information.

12. The viewing management method according to claim 8, wherein the generating display data sets spare time zones in advance in the list information columns, retrieves VOD content having reproduction times going in the spare time zones, and inserts content information being fit for the retrieved VOD content into the spare time zones.

13. The viewing management method according to claim 8, wherein:
when the VOD content has not been viewed after elapse of the time zone in which the content information is inserted into the list information columns, the generating display data retrieves the next spare time zone to insert content information of the not-viewed VOD content into the retrieved spare time zone.

14. The viewing management method according to claim 8, wherein:
when the broadcast reception processing unit includes a viewing reservation means for receiving a viewing reservation for the broadcast program from a user, the generating display data gives the viewing reservation for the broadcast programs preference to shift content information of the viewing schedule if a time zone in a list information column into which the content information is inserted as the viewing schedule is overlapped with a time zone of the broadcast program of which the viewing has been reserved.
